(19) United States
(12) Patent Application Publication
(10) Pub. No.: US 2015/0211558 A1
(43) Pub. Date: Jul. 30, 2015

(54) DEVICES AND METHODS FOR SECURING COMPONENT PIECES

(71) Applicant: COVIDIEN LP, MANSFIELD, MA (US)

(72) Inventor: DAVID M. GARRISON, LONGMONT, CO (US)

(21) Appl. No.: 14/517,109

(22) Filed: Oct. 17, 2014

Related U.S. Application Data
(60) Provisional application No. 61/933,020, filed on Jan. 29, 2014.

(51) Int. Cl. F16B 2/24; F16B 2/22

(52) U.S. Cl. CPC F16B 2/245; F16B 2/22

(57) ABSTRACT

Methods, systems, and devices are described securing component pieces together through a clip that may securely engage with the component pieces. The clip may include a body portion opposite end portions that extend away from a medial portion. One of the end portions may be joined to a securement feature of a first component piece and include a number of cantilevered beams that extend away from the medial portion and engage the securement feature of the first component piece. Similarly, the other end portion may be joined to a securement feature of a second component piece, and also include a number of cantilevered beams that extend away from the medial portion and engage the securement feature of the second component piece. The oppositely extending cantilevered beams may act to secure the clip from being removed from the respective component piece, and thereby securely fasten the two component pieces together.

### CROSS REFERENCE TO RELATED APPLICATION

The present application claims the benefit of and priority to U.S. Provisional Application Ser. No. 61/933,020, filed on Jan. 29, 2014, the entire contents of which are incorporated herein by reference.

### BACKGROUND

The following relates generally to systems, devices and related methods for securing component pieces of an assembly together. More specifically, the present disclosure relates to clips having cantilevered beams that engage with one or more component pieces and fasten the component pieces together.

Various types of products are assembled using housings that encase internal parts. Such internal parts may include particular parts assembled to perform the desired function of the particular product being assembled. The housings for such products may provide support for the internal parts and further enable the performance of the desired function of the particular product. Housings may themselves be assembled from two or more component pieces that are secured together to encase the internal parts of the products. The component pieces of a housing may be secured together in a number of fashions such as through adhesives, welding, screws, bolts and nuts, and/or rivets, to name just a few examples. The particular mechanism for securing housing component pieces may be selected based on any of a number of factors, including the end use of the product, desired ease for accessing internal parts, product size, design criteria, and/or manufacturing efficiency, to name just a few examples.

In many products, it may be desirable to permanently or semi-permanently fasten housing component pieces together. In such products, housing component pieces may be secured using known techniques such that all or a portion of the housing may be destroyed if disassembled, or that the housing may be disassembled only through the use of one or more specialized tools. In some situations, housing component pieces may be secured such that disassembly may be readily detected, which may, for example, void a warranty. However, many techniques that result in permanent or semi-permanent connection of housing component pieces may be relatively inefficient to manufacture. Accordingly, efficient and effective securement of component pieces would be desirable, while also maintaining other beneficial properties of the assembled product.

### SUMMARY

Various methods, systems, devices, and apparatuses are described for securing component pieces together through a fastener that may securely engage with the component pieces. The fastener may include a body portion opposite end portions that extend away from a medial portion. One of the end portions may be joined to a securement feature of a first component piece and include a number of cantilevered beams that extend away from the medial portion and engage the securement feature of the first component piece. Similarly, the other end portion may be joined to a securement feature of a second component piece, and also include a number of cantilevered beams that extend away from the medial portion and engage the securement feature of the second component piece. The oppositely extending cantilevered beams may act to secure the fastener from being removed from the respective component piece, and thereby securely fasten the two component pieces together.

According to some aspects, an apparatus for securing a component piece to a medical device is provided. The apparatus may include a body portion having a first end portion and a second end portion, the first end portion configured to engage a securement feature of a first component piece, and a number of cantilevered beams on the first end portion, one or more of the cantilevered beams having a distal end that extends away from the second end portion toward a distal end of the first end portion, and one or more of the cantilevered beams may be configured to engage the securement feature of the component piece. In some embodiments, the second end portion may include a second number of cantilevered beams, one or more of which having a distal end that extends away from the first end portion toward a distal end of the second end portion and configured to engage a second securement feature of the medical device.

According to some other aspects, a method for assembling a medical device is provided. The method may include coupling a fastener to a first component part of the medical device, the fastener including a body portion having a number of cantilevered beams that extend away therefrom, aligning the fastener with a securement feature of a second component part of the medical device, and engaging the fastener with the securement feature by moving the second component part into contact with the first component part. In some embodiments, the body portion may include first and second end portions, one or both of which having one or more of the features discussed above. In some embodiments, coupling the fastener to the first component part may include aligning the fastener with a first component part securement feature and pushing the fastener into engagement with the first component part securement feature, thereby coupling the fastener with the first component part. Such a securement feature may include, for example, a rib, a socket, and/or a slot. Engaging the fastener with the securement feature may include, in some embodiments, biasing the first component part toward the second component part.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an exploded view of a medical device and housing component pieces that may be secured together using fasteners, in accordance with various aspects of the present disclosure;

FIG. 2 is a perspective view of a rib fastener in accordance with various embodiments of the present disclosure;

FIG. 3 is cross section of a portion of a housing securement feature and a rib fastener in accordance with various embodiments of the present disclosure;

FIG. 4 is a perspective view of a pin fastener in accordance with various embodiments of the present disclosure;

FIG. 5 is cross section of a portion of a housing securement feature and a pin fastener in accordance with various embodiments of the present disclosure;

FIG. 6 is a perspective view of a post fastener in accordance with various embodiments of the present disclosure;

FIG. 7 is cross section of a portion of a housing securement feature and a post fastener in accordance with various embodiments of the present disclosure;

FIG. 8A is a side view of a slot fastener in accordance with various embodiments of the present disclosure;

FIG. 8B is a perspective view of a slot fastener in accordance with various embodiments of the present disclosure;

FIG. 9 is cross section of a portion of a housing securement feature and a slot fastener in accordance with various embodiments of the present disclosure;

FIG. 10 is a perspective view of a long slot fastener in accordance with various embodiments of the present disclosure;

FIG. 11 is cross section of a combination fastener and a portion of a housing securement feature in accordance with various embodiments of the present disclosure;

FIG. 12 is a perspective view of a multi-pin fastener in accordance with various embodiments of the present disclosure;

FIG. 13 is cross section of securement features of multiple housing component pieces and a multi-pin fastener in accordance with various embodiments of the present disclosure;

FIG. 14 is a top view of a slot fastener and tensioning member in accordance with various embodiments of the present disclosure;

FIG. 15 is another top view of a slot fastener and tensioning member in an expanded configuration in accordance with various embodiments of the present disclosure;

FIG. 16 is cross section of securement features of multiple housing component pieces and a self-tensioning slot fastener in an unsecured state in accordance with various embodiments of the present disclosure;

FIG. 17 is cross section of securement features of multiple housing component pieces and a self-tensioning slot fastener in a secured state in accordance with various embodiments of the present disclosure;

FIG. 18 is a top view of an oval spring clip fastener and tensioning member in an expanded configuration in accordance with various embodiments of the present disclosure;

FIG. 19 is cross section of securement features of multiple housing component pieces and an oval spring clip fastener with a standoff that is released when the component pieces are moved together;

FIG. 20 is a top view of an oval spring clip fastener and tensioning member in an unexpanded configuration in accordance with various embodiments of the present disclosure;

FIG. 21 is a top view of the oval spring clip fastener and tensioning member of FIG. 20 in an expanded configuration in accordance with various embodiments of the present disclosure;

FIG. 22 is cross section of securement features of multiple housing component pieces and an oval spring clip fastener with a standoff that is released when the component pieces are moved together;

FIG. 23 is a top view of a slot fastener and tensioning member in an unexpanded configuration in accordance with various embodiments of the present disclosure;

FIG. 24 is a top view of the slot fastener and tensioning member of FIG. 20 in an expanded configuration in accordance with various embodiments of the present disclosure;

FIG. 25 is a perspective view of a post with internal spring in accordance with various embodiments of the present disclosure;

FIG. 26 is a cross section view of the post fastener with a separate internal spring in accordance with various embodiments of the present disclosure;

FIG. 27 is cross section showing securement features of multiple housing component pieces and a post fastener with internal spring in accordance with various embodiments of the present disclosure;

FIG. 28 is cross section showing molded retainers that may be engaged with a cantilever beam fastener that extends through openings in component pieces (of a housing or other components) in accordance with various embodiments of the present disclosure;

FIG. 29 is cross section of an overmolded fastener in accordance with various embodiments of the present disclosure;

FIG. 30 is a flow chart of the operations for assembling a device using a fastener in accordance with various embodiments of the present disclosure; and

FIG. 31 is another flow chart of the operations for assembling a device using a fastener in accordance with various embodiments of the present disclosure.

### DETAILED DESCRIPTION

The present disclosure generally relates to methods, systems, devices, and apparatuses for securing component pieces together through a fastener that may securely engage with the component pieces. The fastener may include a body portion opposite end portions that extend away from a medial portion. One of the end portions may be joined to a securement feature of a first component piece and include a number of cantilevered beams that extend away from the medial portion and engage the securement feature of the first component piece. Similarly, the other end portion may be joined to a securement feature of a second component piece, and also include a number of cantilevered beams that extend away from the medial portion and engage the securement feature of the second component piece. The oppositely extending cantilevered beams may act to secure the fastener from being removed from the respective component piece, and thereby securely fasten the two component pieces together.

Various embodiments described herein refer to component pieces of a medical device, such as a pistol-gripped vessel sealing device. In many cases, such devices may have a number of internal components that are encased within a housing. Such a housing may have two (or more) housing component pieces that are secured together during the manufacturing and assembly process. In some cases, a bottom housing component may be placed on a workbench or other work surface, and various internal components placed within the housing. A top housing component may then be placed on the bottom housing component piece and secured to the bottom housing component piece to form the finished product. It is desirable to have the housing component pieces secured together in a highly reliable fashion, as a failure in such a connection may cause a safety concern for medical personnel and/or patients. In many manufacturing processes, the housing component pieces are formed primarily of plastic, and an ultrasonic welder may be used to secure the housing component pieces together with a reliable connection.

While an ultrasonic welder may be used to provide a clean and reliable connection between the housing component pieces. Such an operation may create manufacturing difficulties for a variety of reasons. For example, in many cases the housing component pieces have curved surfaces, which can lead to increased setup time and operation time for the ultrasonic welding operation. Furthermore, in some cases pressure may not be able to be applied evenly across the entire surface of the housing component pieces. This may be due to gripping material being incorporated into certain areas of the housing, for example. Such non-uniform pressure may add setup time to the manufacturing process. Additionally, ultrasonic welding equipment can be expensive and consume valuable manufacturing floor space. Various aspects of the present disclosure provide a number of alternatives that may reduce or eliminate the need for ultrasonic welding when assembling such medical device housing component pieces, with several examples discussed below. The present disclosure may also be used with other materials including but not limited to metals, composites and ceramics. Furthermore, aspects of the disclosure may suitably replace fastening processes other than ultrasonic welding such as, for example, threaded fasteners, adhesives, solvent bonding, heat staking, press fits and snap fits. While various embodiments are described herein in relation to such a medical device, it is to be understood that various other embodiments may be used in non-medical device applications.

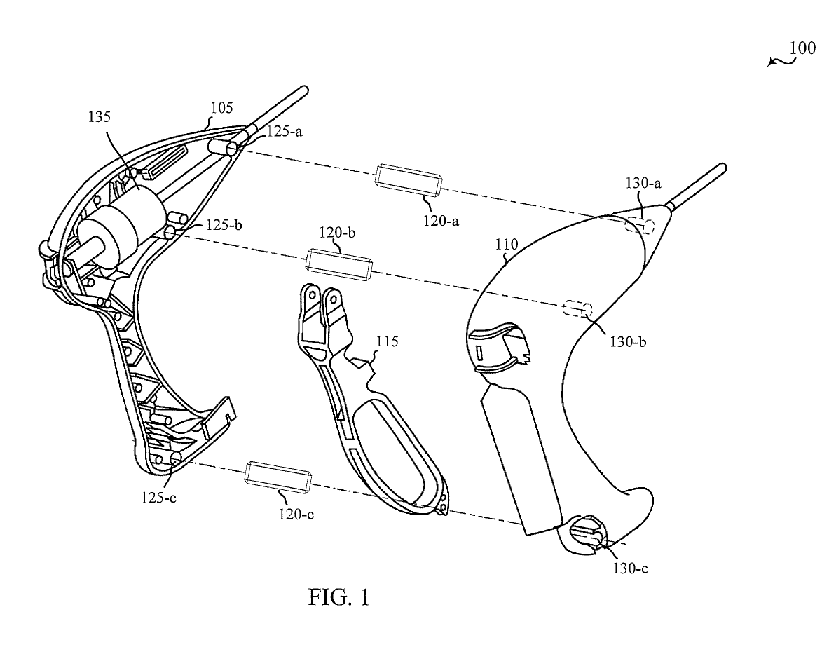

Referring now to FIG. 1, a pistol-grip medical device 100 is illustrated. Such a medical device 100 may be used for vessel sealing of a patient undergoing a medical procedure, for example. In the example of FIG. 1, the medical device 100 includes two housing component pieces, namely a first housing component piece 105 and a second housing component piece 110. An actuator handle 115 may be coupled between the housing component pieces 105 and 110, which may be used by medical personnel to activate an electrode coupled to the medical device, for example. The first housing component piece 105 and second housing component piece 110, according to various embodiments, may be secured together using a plurality of fasteners 120-a, 120-b, and 120-c. Each of the fasteners 120-a-120-c may engage with a corresponding securement feature 125-a-125-c of the first housing component piece, and may also engage with corresponding securement features 130-a-130-c of the second housing component piece when the component pieces 105, 110 are assembled together. The fasteners 120 may frictionally engage with securement features 125, 130 to retain the housing component pieces 105, 110 in an assembled fashion. In some embodiments, as will be described in more detail below, fasteners 120 each have one or more cantilevered beams that may engage securement features 125, 130. In some embodiments, fasteners 120 may include a tensioning member that may bias the housing component pieces 150, 110 toward each other, and securely couple the housing component pieces 105, 110 together.

Using fasteners 120 to secure the housing component pieces 105, 110 together may reduce or eliminate the need to use other securement techniques in the assembly of medical device 100. For example, in some embodiments, various internal components 135 may be placed within first housing component piece 105. Fastener 120-a may be inserted into securement feature 125-a. In some embodiments, as will be discussed in more detail below, securement feature 125-a may be a socket configured to receive a first end of a round post-shaped fastener 120-a. Fasteners 120-b and 120-c, and securement features 125-b and 125-c may be similarly configured. When the internal components 135 and fasteners 120 have been coupled with the first housing component piece 105, the second housing component piece 110 may be moved into position to engage with the fasteners 120. According to some embodiments, securement features 130-a, 130-b, and 130-c each engage with a second end of fasteners 120-a, 120-b, and 120-c, respectively.

Accordingly, the first and second housing component pieces 105, 110 may be mechanically coupled without the need for any tools or equipment. Such assembly may provide enhanced efficiency for manufacturing of the device 100, and may also result in the requirement for less tooling that may consume valuable manufacturing floor space. Furthermore, manufacturing efficiency may be enhanced through reduced requirements to setup and operate equipment, such as ultrasonic welding equipment, required for the manufacturing and assembly of the device 100. In some embodiments, as will be discussed in more detail below, fasteners 120 may be formed of relatively inexpensive material that is relatively easy and inexpensive to fabricate. For example, in some embodiments, fasteners 120 may be formed from a stamped and shaped piece of sheet metal. Such fasteners may further enhance manufacturing efficiency. Through enhanced manufacturing efficiency, lower cost of manufacturing equipment, and relatively low cost fastening components, the overall cost to make such a device 100 may be reduced. Furthermore, in some embodiments, fasteners 120 may be configured such that the housing component pieces 105, 110, may not be disassembled without causing significant damage, or destroying, medical device 100, thus reducing the potential for third parties to re-work the device 100 following an initial sale of the device 100.

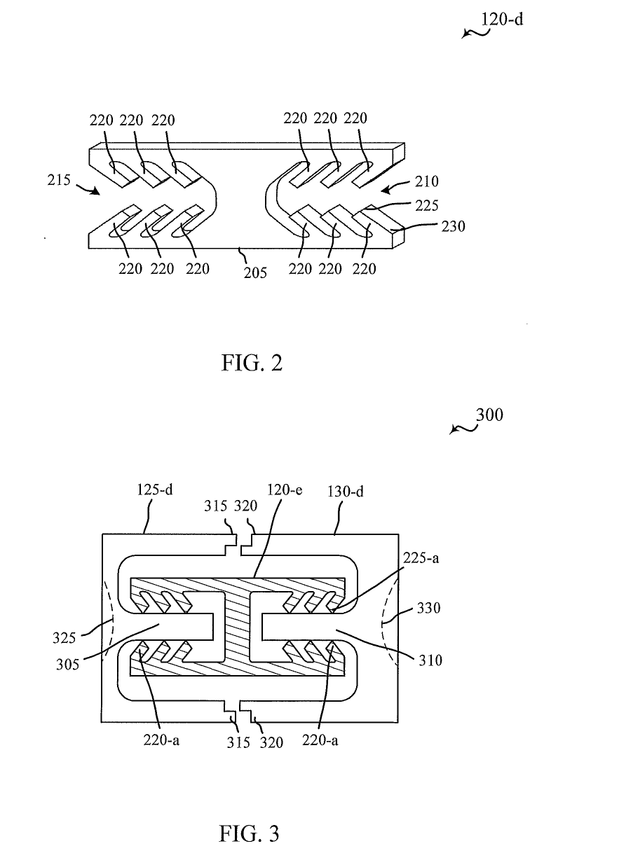

With reference now to FIG. 2, a rib fastener 120-d of one set of embodiments is described. Fastener 120-d may be an example of one or more fasteners 120-a-120-c of FIG. 1. In the example of FIG. 2, fastener 120-d is a rib fastener having a body portion 205, a first end portion 210, and a second end portion 215. In this example, end portions 210 and 215 are in the form of clips that each have a number of cantilevered beams 220 that extend inwardly therefrom. The cantilevered beams 220 extend away from each respective end portion 210, 215 and toward the opposing end portion 215, 210, respectively. The cantilevered beams 220 each have distal end portions or tips 225 and tail ends 230 connected to the body portion 205. Cantilever beams 220 may have a uniform thickness throughout the length of the beam 220, or may have a tapered configuration such that the thickness can vary between tail ends 230 and tips 225. Leading edges of tips 225 may can include undulations, patterns, cut out portions and/or surface finishes to improve the positioning, grip, or retention of fastener 120-d with a component piece.

Cantilever beams 220 may flex about the vicinity of the junction of tail ends 230 and the body portion 205. Body portion 205, in some embodiments, is selected to have thickness and material properties to provide sufficient structural integrity to inhibit the bending of the body portion 205 and to bias cantilever beams 220 at the desired angle. In some embodiments, cantilever beams 220 have a generally rigid or semi-rigid construction and are configured to resist, for example, torquing forces about axes parallel with a longitudinal axis of fastener 120-d. Fastener 120-d may be fabricated of a suitable metal, composite, or plastic material providing structural rigidity and appropriate bias to cantilever beams 220. Fastener 120-d may have a uniform composition, different body portion 205 and cantilever beam 220 materials, or have a laminated structure of varying composition, for example. In some embodiments, fastener 120-d may be formed from a stamped piece of sheet metal.

With reference now to FIG. 3 a cross-section 300 of a portion of housing securement features and a rib fastener is described in accordance with various embodiments of the present disclosure. In the example of FIG. 3, fastener 120-e may be used to couple a first securement feature 125-d and a second securement feature 130-d. Fastener 120-e may be an example of fastener 120-d of FIG. 2, and may be an example of one or more fasteners 120-a-120-c of FIG. 1. Securement feature 125-d may be an example of one or more of securement features 125-a-125-c of FIG. 1. Likewise, securement feature 130-d may be an example of one or more of securement features 130-a-130-c of FIG. 1. In this example, securement feature 125-d includes a rib 305 that engages with cantilevered beams 220-a of fastener 120-e. Likewise, securement feature 130-d includes a rib 310 that engages with cantilevered beams 220-a of fastener 120-e. Securement feature 125-d in this example includes alignment features 315 that may engage with complimentary alignment features 320 of securement feature 130-d, and may assist in maintaining proper alignment of the connected component pieces.

Similarly as discussed above, fastener 120-e may be formed from any of a number of different materials, or combinations of materials, and in some embodiments may be formed from a stamped piece of sheet metal. In some embodiments, the material of fastener 120-e is selected to have a hardness that is greater than the hardness of the securement features 125-d and 130-d. In such a manner, tips 225-a of cantilever beams 220-a may pierce the surface of the ribs 305 and 310 and prevent the ribs 305, 310 from being withdrawn back out of the fastener 120-e. Fastener 120-e thereby retains the securement features 125-d and 130-d in a connected state. In some embodiments, securement features 125-d and 130-d are formed form plastic and fastener 120-e is formed from relatively hard metal, and thus tips 225-a of cantilever beams 220-a may penetrate into the surface of ribs 305 and 310 to a significant degree, preventing the securement features 125-d and 130-d from being separated without causing some amount of damage to the respective securement features 125-d, 130-d, and/or fastener 120-e.

In some embodiments, the securement features 125-d and 130-d may be overdriven, or overcompressed, when coupled with fastener 120-e by applying sufficient force to partially deform an outer surface of a component piece that includes the respective securement features 125-d and 130-d. Such deformation is illustrated by the dashed lines 325 and 330 of securement features 125-d and 130-d. By overdriving securement features 125-d and 130-d in such a manner, the fastener 120-e may be preloaded with some tension in order to more securely couple securement features 125-d and 130-d together. Securement features 125-d and 130-d may be overdriven by applying a sufficient amount of pressure to an external surface of the securement features 125-d and 130-d in the area associated with ribs 305 and 310. Such pressure may be applied by a tool configured for use with the assembly of an associated housing, for example. In some embodiments, the external surface associated with ribs 305 and 310 may have a marking or other indication that may be used during manufacturing or assembly of the associated device to properly apply the sufficient amount of pressure to achieve such preloading.

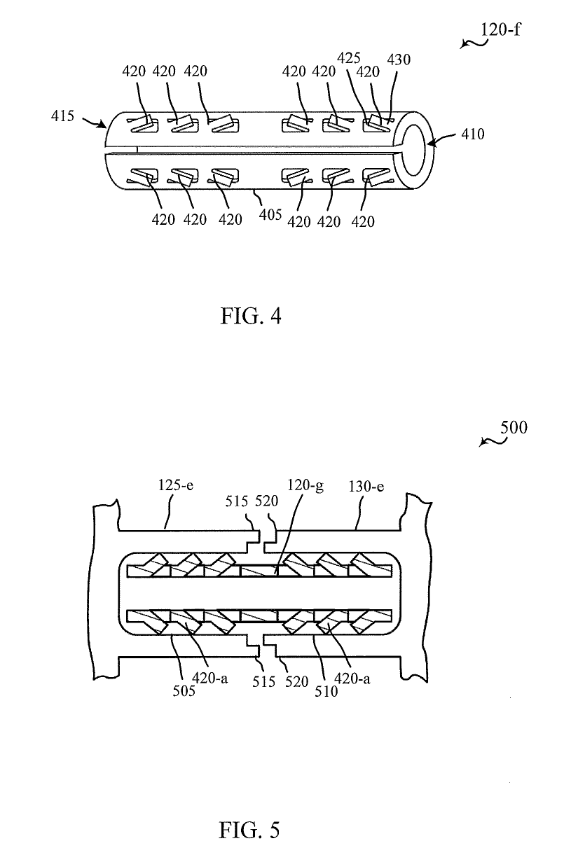

With reference now to FIG. 4, a pin fastener 120-f of one set of embodiments is described. Fastener 120-f may be an example of one or more fasteners 120-a-120-c of FIG. 1. In the example of FIG. 4, fastener 120-f is a pin fastener having a body portion 405, a first end portion 410, and a second end portion 415. In this example, end portions 410 and 415 are in the form of a pin or post and have a number of cantilevered beams 420 that extend therefrom. The cantilevered beams 420 extend away from each respective end portion 410, 415 and toward the opposing end portion 415, 410, respectively. The cantilevered beams 420 each have front end portions or tips 425 and tail ends 430 connected to the body portion 405.

Cantilever beams 420 may have a uniform thickness throughout the length of the beam 420, or may have a tapered configuration such that the thickness can vary between tail ends 430 and tips 425. Leading edges of tips 425 may can include undulations, patterns, cut out portions and/or surface finishes to improve the positioning, grip, or retention of fastener 120-f with a component piece. Cantilever beams 420 and body portion 405 may have physical characteristics related to flexing, thickness, and material properties similar to cantilevered beams 220 and body portion 205 of FIG. 2, which are not repeated here for the sake of brevity.

With reference now to FIG. 5 a cross-section 500 of a portion of housing securement features 125-e and 130-e and a pin fastener 120-g is described in accordance with various embodiments. In the example of FIG. 5, fastener 120-g may be used to couple a first securement feature 125-e and a second securement feature 130-e. Fastener 120-g may be an example of fastener 120-f of FIG. 4, and may be an example of one or more fasteners 120-a-120-c of FIG. 1. Securement feature 125-e may be an example of one or more of securement features 125-a-125-c of FIG. 1. Likewise, securement feature 130-e may be an example of one or more of securement features 130-a-130-c of FIG. 1. In this example, securement feature 125-e includes a socket having a sidewall 505 that engages with cantilevered beams 420-a of fastener 120-g. Likewise, securement feature 130-e includes a sidewall 510 that engages with cantilevered beams 420-a of fastener 120-g. Securement feature 125-e in this example includes alignment features 515 that may engage with complimentary alignment features 520 of securement feature 130-e, and may assist in maintaining proper alignment of the connected component pieces.

Similarly as discussed above, fastener 120-g may be formed from any of a number of different materials, or combinations of materials, and in some embodiments may be formed from a stamped piece of sheet metal. In some embodiments, the material of fastener 120-g is selected to have a hardness that is greater than the hardness of the securement features 125-e and 130-e. In such a manner, tips 425-a of cantilever beams 420-a may pierce the surface of the sidewalls 505 and 510 and prevent the sidewalls 505, 510 from being withdrawn back out of the fastener 120-g. Fastener 120-g thereby retains the securement features 125-e and 130-e in a connected state. In some embodiments, securement features 125-e and 130-e are formed form plastic and fastener 120-g is formed from relatively hard metal, and thus tips 425-a of cantilever beams 420-a may pierce the surface of sidewalls 505 and 510 to a significant degree, preventing the securement features 125-e and 130-e from being separated without causing some amount of damage to the respective securement features 125-e, 130-e, and/or fastener 120-g.

With reference now to FIG. 6, a post fastener 120-h of one set of embodiments is described. Fastener 120-h may be an example of one or more fasteners 120-a-120-c of FIG. 1. In the example of FIG. 6, fastener 120-h is a post fastener having a body portion 605, a first end portion 610, and a second end portion 615. In this example, end portions 610 and 615 are in the form of a socket that may receive a central grip post or pin, and have a number of cantilevered beams 620 that extend therefrom. The cantilevered beams 620 extend away from each respective end portion 610, 615 and toward the opposing end portion 615, 610, respectively. The cantilevered beams 620 extend inwardly from body portion 605 toward an internal cavity of the body portion 605. Cantilever beams 620 and body portion 605 may have physical characteristics related to flexing, thickness, and material properties similar to cantilevered beams 220 and body portion 205 of FIG. 2, which are not repeated here for the sake of brevity. According to sole embodiments, a post fastener 120-h such as illustrated in FIG. 6 may be formed from a stamped sheet of metal that is rolled to form the post. The seam 625 at the ends of the metal sheet may be closed or bonded, according to various embodiments, to prevent expansion of the body 605 and provide adequate gripping force. In other embodiments, seam 625 may not be closed or bonded, as illustrated in FIG. 6. Whether or not to close and/or bond seam 625 may be determined based on particular requirements of an application and based on material properties of the material used to form the post fastener 120-h.

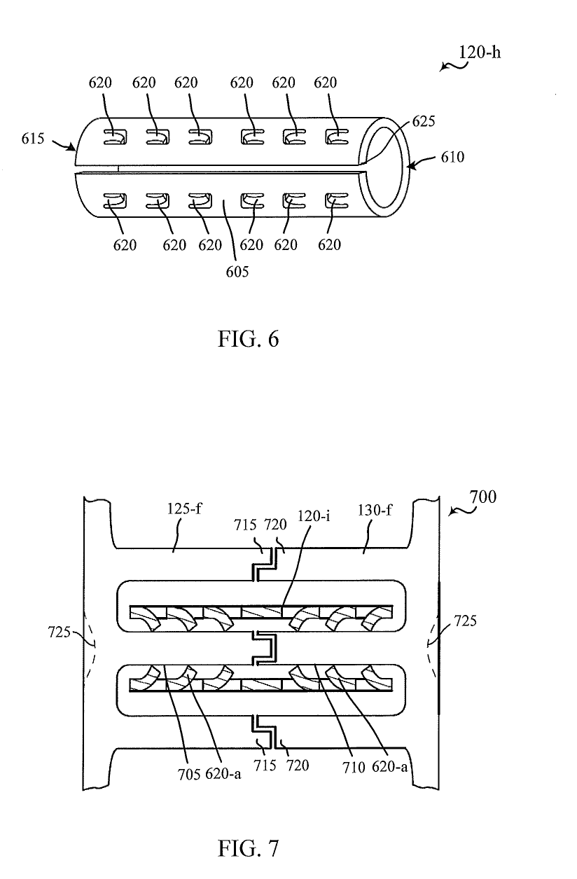

With reference now to FIG. 7 a cross-section 700 of a portion of housing securement features 125-f and 130-f and a post fastener 120-i is described in accordance with various embodiments. In the example of FIG. 7, fastener 120-i may be used to couple a first securement feature 125-f and a second securement feature 130-f. Fastener 120-i may be an example of fastener 120-h of FIG. 6, and may be an example of one or more fasteners 120-a-120-c of FIG. 1. Securement feature 125-f may be an example of one or more of securement features 125-a-125-c of FIG. 1. Likewise, securement feature 130-f may be an example of one or more of securement features 130-a-130-c of FIG. 1. In this example, securement feature 125-f includes a central grip post having a sidewall 705 that extends into fastener 120-i and engages with cantilevered beams 620-a of fastener 120-i. Likewise, securement feature 130-f includes a post having a sidewall 710 that extends into fastener 120-i and engages with cantilevered beams 620-a of fastener 120-i. Securement feature 125-f in this example includes alignment features 715 that may engage with complimentary alignment features 720 of securement feature 1304, and may assist in maintaining proper alignment of the connected component pieces.

Similarly as discussed above, fastener 120-i may be formed from any of a number of different materials, or combinations of materials, and in some embodiments may be formed from a stamped piece of sheet metal. In some embodiments, the material of fastener 120-i is selected to have a hardness that is greater than the hardness of the securement features 125-f and 1304, and thereby provide similar properties and behaviors as discussed above with respect to FIGS. 3 and 5. Similarly as discussed above with respect to FIG. 3, the securement features 125-f and 130-f may be overdriven as indicated at 725 when coupled with fastener 120-i by applying sufficient force to partially deform an outer surface of a component piece that includes the respective securement features 125-f and 130-f. By overdriving securement features 125-f and 130-f in such a manner, the fastener 120-i may be preloaded with some tension in order to more securely couple securement features 125-f and 130-f together.

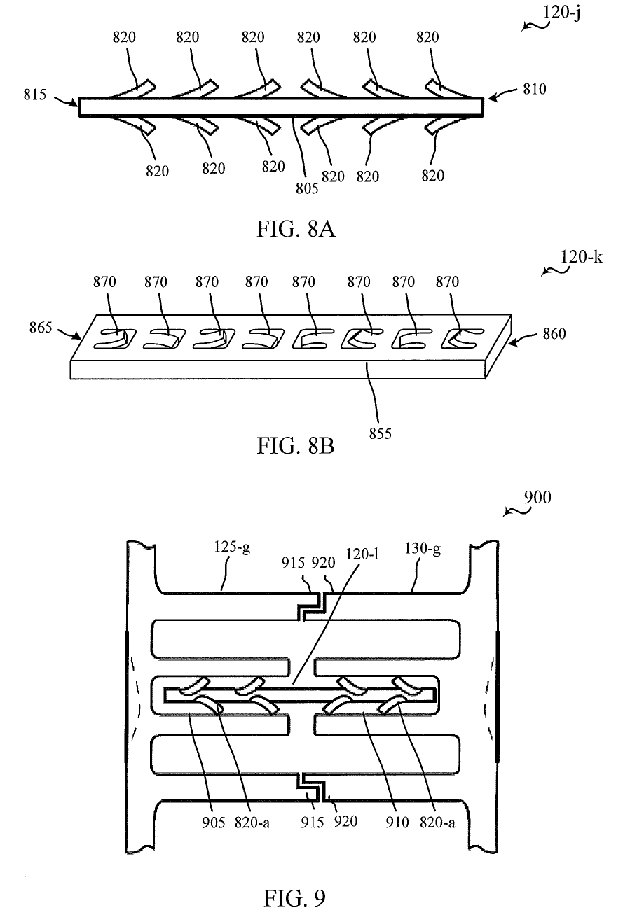

With reference now to FIG. 8A and FIG. 8B, slot fasteners 120-j and 120-k of various embodiments are described. Fasteners 120-j and 120-k may be examples of one or more fasteners 120-a-120-c of FIG. 1. In the example of FIG. 8A fastener 120-j is a slot fastener having a body portion 805, a first end portion 810, and a second end portion 815. In this example, end portions 810 and 815 are in the form of a strip or plate that may be aligned with and inserted into a corresponding slot of a component piece, and have a number of cantilevered beams 820 that extend therefrom. The cantilevered beams 820 extend away from each respective end portion 810, 815 and toward the opposing end portion 815, 810, respectively. Cantilever beams 820 and body portion 805 may have physical characteristics related to flexing, thickness, and material properties similar to cantilevered beams 220 and body portion 205 of FIG. 2, which are not repeated here for the sake of brevity.

Similarly, in the example of FIG. 8B fastener 120-k is a slot fastener having a body portion 855, a first end portion 860, and a second end portion 865. In this example, end portions 860 and 865 are in the form of a strip that may be inserted into a corresponding slot of a component piece, and have a number of cantilevered beams 870 that extend therefrom. Adjacent cantilevered beams 870, in this example, extend in opposite directions away from each other. Cantilever beams 870 and body portion 865 may have physical characteristics related to flexing, thickness, and material properties similar to cantilevered beams 220 and body portion 205 of FIG. 2, which are not repeated here for the sake of brevity.

With reference now to FIG. 9 a cross-section 900 of a portion of housing securement features 125-g and 130-g and a slot fastener 120-I is described in accordance with various embodiments. In the example of FIG. 9, fastener 120-I may be used to couple a first securement feature 125-g and a second securement feature 130-g. Fastener 120-I may be an example of fastener 120-j of FIG. 8A, and may be an example of one or more fasteners 120-a-120-c of FIG. 1. Fastener 120-I may have similar characteristics as fastener 120-k of FIG. 8B, with the differences being adjacent cantilever beams extending in different directions. Securement feature 125-g may be an example of one or more of securement features 125-a-125-c of FIG. 1. Likewise, securement feature 130-g may be an example of one or more of securement features 130-a-130-c of FIG. 1. In this example, securement feature 125-g includes a slot having a sidewall 905 that receives fastener 120-I and engages with cantilevered beams 820-a of fastener 120-I. Likewise, securement feature 130-g includes a slot having a sidewall 910 that receives fastener 120-I and engages with cantilevered beams 820-a of fastener 120-I. Securement feature 125-g in this example includes alignment features 915 that may engage with complimentary alignment features 920 of securement feature 130-g, and may assist in maintaining proper alignment of the connected component pieces.

Similarly as discussed above, fastener 120-I may be formed from any of a number of different materials, or combinations of materials, and in some embodiments may be formed from a stamped piece of sheet metal. In some embodiments, the material of fastener 120-I is selected to have a hardness that is greater than the hardness of the securement features 125-g and 130-g, and thereby provide similar properties and behaviors as discussed above with respect to FIGS. 3 and 5. Similarly as discussed above with respect to FIG. 3, the securement features 125-g and 130-g may be overdriven when coupled with fastener 120-I by applying sufficient force to partially deform an outer surface of a component piece that includes the respective securement features 125-g and 130-g. By overdriving securement features 125-g and 130-g in such a manner, the fastener 120-I may be preloaded with some tension in order to more securely couple securement features 125-g and 130-g together.

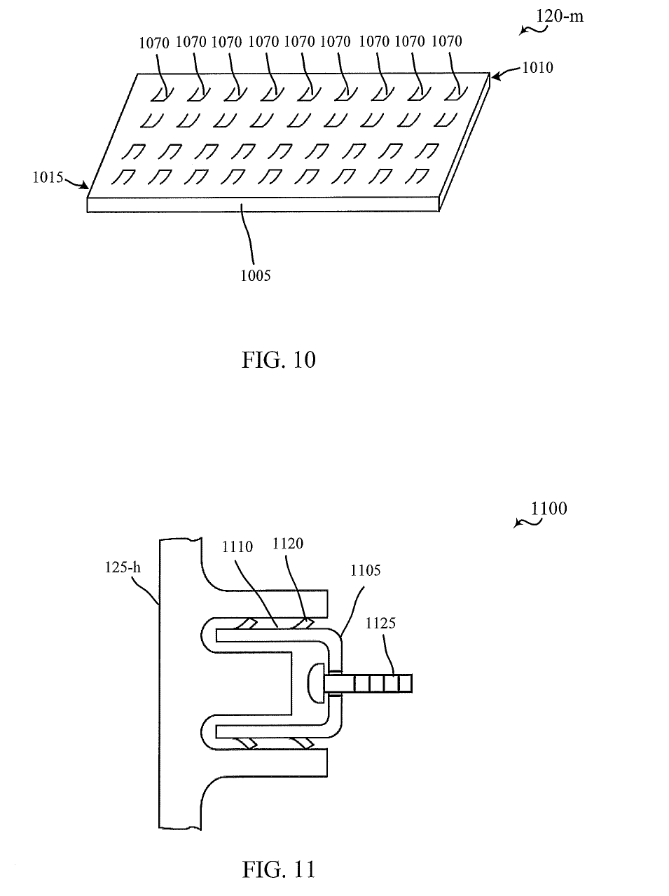

With reference now to FIG. 10, a long slot fastener 120-m of various embodiments is described. Fastener 120-m may be an example of one or more fasteners 120-a-120-c of FIG. 1. In the example of FIG. 10 fastener 120-m is a slot fastener having a body portion 1005, a first end portion 1010, and a second end portion 1015. In this example, end portions 1010 and 1015 are in the form of an elongated strip that may be inserted into a corresponding slot of a component piece, and have a number of cantilevered beams 1020 that extend therefrom. In some embodiments, the elongated slot may have some amount of curvature, such as associated with a curved surface of a housing and may secure housing component pieces together along a substantial length of such a curved surface. The cantilevered beams 1020 extend away from each respective end portion 1010, 1015 and toward the opposing end portion 1015, 1010, respectively. Beams 1020 may all be oriented with tips facing towards top of body 1005, as shown in FIG. 10, or with tips facing alternating sides. Cantilever beams 1020 and body portion 1005 may have physical characteristics related to flexing, thickness, and material properties similar to cantilevered beams 220 and body portion 205 of FIG. 2, which are not repeated here for the sake of brevity.

With reference now to FIG. 11 a combination fastener 1100 is described in accordance with various embodiments. Fastener 1100 may be an example of one or more fasteners 120-a-120-c of FIG. 1. In the example of FIG. 11 fastener 1100 is a combination fastener having a body portion 1105, a first end portion 1110, and a shaft member 1125 that extends from the body portion 1105. In this example, end portion 1110 is in the form of a post that may be inserted into a complimentary socket of a housing securement feature 125-h, and includes a number of cantilevered beams 1120 that extend therefrom to secure the end portion 1110 into housing securement feature 125-h, similarly as described above. Beams 1120 may all be oriented with tips facing away from shaft 1125, as shown in FIG. 11, or with tips facing alternating sides. Body 1105 may be constructed from flat material that has been formed with two simple linear bends into the shape shown in the embodiment of FIG. 11, which represents a side view, or it may be formed into a cylindrical shape similar to FIGS. 4 and/or 6 with a cap on one end to hold shaft 1125. Cantilever beams 1120 and body portion 1105 may have physical characteristics related to flexing, thickness, and material properties similar to cantilevered beams 220 and body portion 205 of FIG. 2, which are not repeated here for the sake of brevity.

In the example of FIG. 11, the combination fastener 1100 includes shaft member 1125 which may be, for example, a screw, rivet, bolt, or any other similar device. The shaft member 1125 may engage with an associated securement feature of another component piece, and thereby secure the housing securement feature 125-h with the other component piece. In some embodiments, shaft member 1125 may engage with one side of a housing component piece, and another housing component piece secured thereto by pressing aligned securement feature 125-h onto the end portion 1110. In some embodiments, shaft member 1125 may be attached to or may itself include a number of cantilevered beams and may be secured to an associated component piece similarly as discussed above with respect to other fasteners.

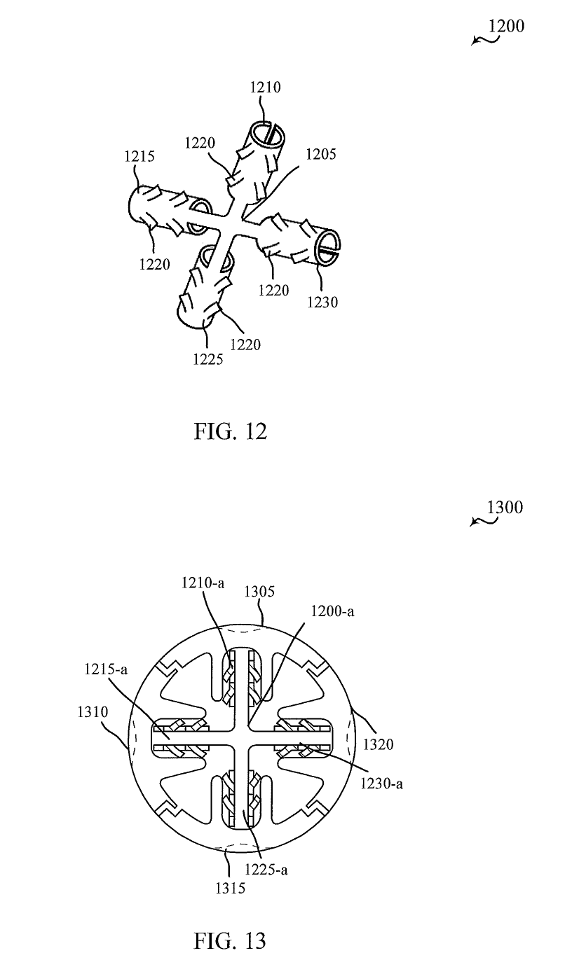

With reference now to FIG. 12, a multi-pin fastener 1200 of a set of embodiments is described. Fastener 1200 may be used to couple multiple component pieces together in a manner similarly as described above. In the example of FIG. 12, fastener 1200 is a multi-pin fastener having a body portion 1205, and first through fourth end portions 1210, 1215, 1225, and 1230, respectively. In this example, end portions 1210, 1215, 1225, and 1230 are in the form of pins that may extend into sockets of associated securement features, and have a number of cantilevered beams 1220 that extend therefrom. The cantilevered beams 1220 extend away from each respective end portion 1210, 1215, 1225, and 1230 and toward a central portion of the body member 1205. The cantilevered beams 1220 extend outwardly from body portion 1205. Cantilever beams 1220 and body portion 1205 may have physical characteristics related to flexing, thickness, and material properties similar to cantilevered beams 220 and body portion 205 of FIG. 2, which are not repeated here for the sake of brevity.

With reference now to FIG. 13 a cross-section 1300 of a portion of housing securement features 1305-1320 and a multi-pin fastener 1200-a is described in accordance with various embodiments. In the example of FIG. 13, fastener 1200-a may be used to couple four separate securement features 1305-1320. Each securement feature 1305-1320 may be associated with a different component piece that is to be secured together. Fastener 1200-a may be an example of fastener 1200 of FIG. 12. In this example, securement features 1305-1320 include sockets having sidewalls that receive end portions 1210-a, 1215-a, 1225-a, and 1230-a and engage with cantilevered beams 1220 of fastener 1200-a.

Similarly as discussed above, fastener 1200-a may be formed from any of a number of different materials, or combinations of materials, and in some embodiments may be formed from a stamped piece of sheet metal. In some embodiments, the material of fastener 1200-a is selected to have a hardness that is greater than the hardness of the securement features 1305-1320, and thereby provide similar properties and behaviors as discussed above with respect to FIGS. 3 and 5. Similarly as discussed above with respect to FIG. 3, the securement features 1305-1320 may be overdriven when coupled with fastener 1200-a by applying sufficient force to partially deform an outer surface of a component piece that includes the respective securement features 1305-1320. By overdriving securement features 1305-1320 in such a manner, the fastener 1200-a may be preloaded with some tension in order to more securely couple securement features 1305-1320 together.

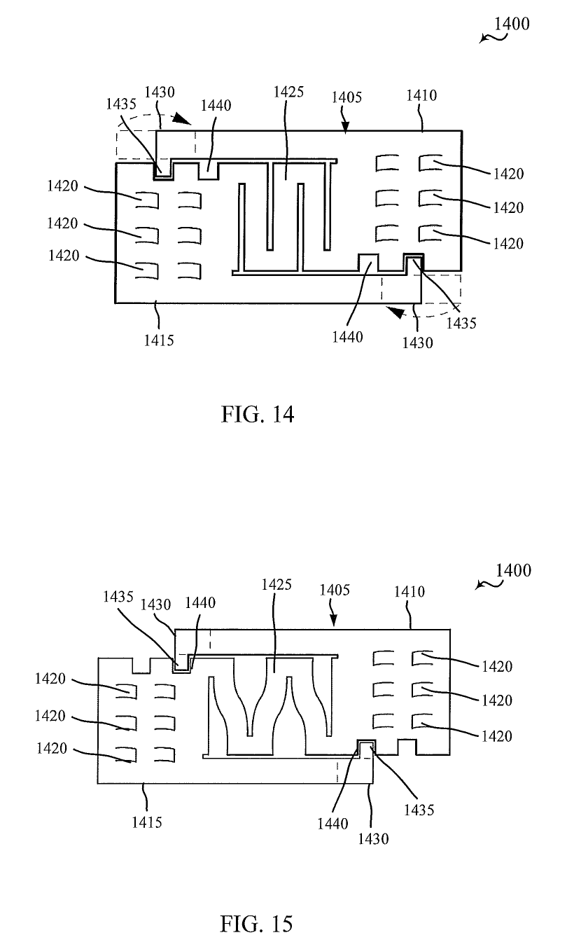

With reference now to FIGS. 14-15, a slot fastener and tensioning member 1400 of a set of embodiments is described. Fastener 1400 may be an example of one or more fasteners 120-a-120-c of FIG. 1. In the example of FIG. 14, fastener 1400 is a slot fastener having a body portion 1405, a first end portion 1410, and a second end portion 1415. In this example, end portions 1410 and 1415 are in the form of a sheet or plate that may be inserted into a slot, and have a number of cantilevered beams 1420 that extend therefrom. The cantilevered beams 1420 extend away from each respective end portion 1410, 1415 and toward the opposing end portion 1415, 1410, respectively. Beams 1420 may all be oriented with tips facing towards one side of body 1405, as shown in FIG. 14, or with tips facing alternating sides. Cantilever beams 1420 and body portion 1405 may have physical characteristics related to flexing, thickness, and material properties similar to cantilevered beams 220 and body portion 205 of FIG. 2, which are not repeated here for the sake of brevity.

The fastener 1400 of FIG. 14 also includes a tensioning member 1425, which is described with respect to FIG. 14 and FIG. 15. According to this example, tensioning member 1425 is in a relaxed state as indicated in FIG. 14, and may be expanded and secured in a pretensioned state as indicated in FIG. 15. Tensioning member 1425 may be expanded, for example, by pulling end portions 1410 and 1415 apart, thus expending tensioning member 1425. According to some embodiments, fastener 1400 may be made from a stamped piece of sheet metal, and expanded tensioning member 1425 acts as a spring that biases end portions 1410 and 1415 toward each other. In the embodiments illustrated, a side bar 1430 may be stamped from the same piece of sheet metal, and may have a tab 1435 that is configured to engage with a corresponding notch 1440 of body portion 1405. When tab 1435 engages notch 1440, the fastener 1400 may be maintained in a pre-tensioned or pre-loaded state. In some embodiments, side bar 1430 may have a portion thereof bent back, as indicated by broken lines and arrows in FIG. 14, that may allow the tab 1435 to be disengaged from notch 1440 when the fastener is connected with component pieces, as will be described in more detail below.

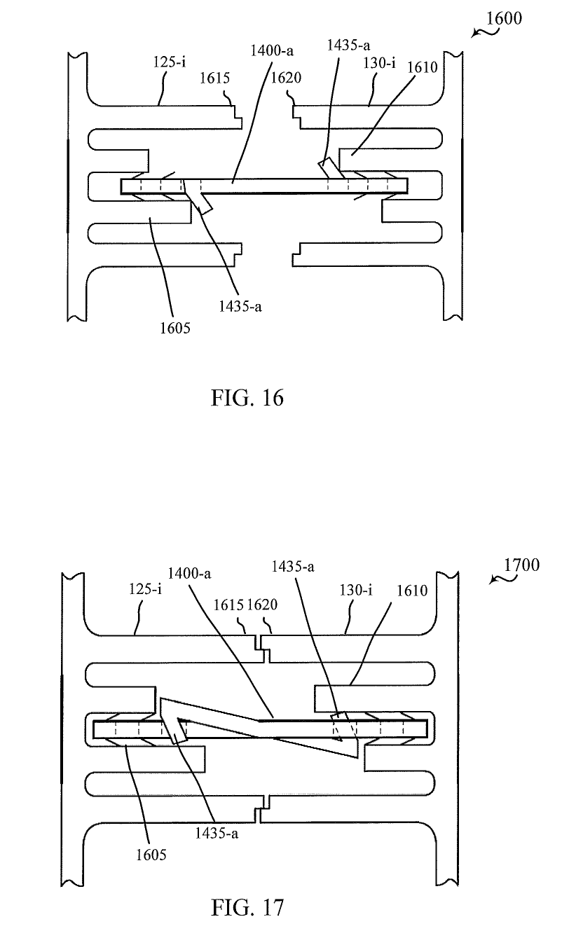

With reference now to FIGS. 16-17, cross-sections 1600 and 1700 of a portion of housing securement features 125-i and 130-i and a slot fastener with tensioning member 1400-a is described in accordance with various embodiments. In the example of FIGS. 16-17, fastener 1400-a may be used to couple a first securement feature 125-i and a second securement feature 130-i, and provide a biasing force that biases first and second securement features 125-i and 130-i towards each other. Fastener 1400-a may be an example of fastener 1400 of FIGS. 14-15, and may be an example of one or more fasteners 120-a-120-c of FIG. 1. Securement feature 125-i may be an example of one or more of securement features 125-a-125-c of FIG. 1. Likewise, securement feature 130-i may be an example of one or more of securement features 130-a-130-c of FIG. 1. In this example, securement feature 125-i includes a long sidewall 1605 that is configured to engage with tab 1435-a. Similarly, securement feature 130-i includes a long sidewall 1610 that is configured to engage with tab 1435-a.

Initially, tab 1435-a may be engaged with notch 1440, when securement features are aligned, but not yet fully engaged, as illustrated in FIG. 16. As securement features 125-i and 130-i are moved toward each other, as illustrated in FIG. 17, long sidewalls 1605 and 1610 engage with tabs 1435-a and move the tabs out of the notch, thereby allowing the tensioning member 1425 to bias securement features 125-i and 130-i towards each other. In such a manner, securement features 125-i and 130-i may be securely held in place. Cantilevered beams located on the fastener 1400-a may operate in a similar fashion as described in any one or more of the above examples, and need not be described in any further detail here. Securement feature 125-i in this example includes alignment features 1615 that may engage with complimentary alignment features 1620 of securement feature 130-i, and may assist in maintaining proper alignment of the connected component pieces.

Similarly as discussed above, fastener 1400-a may be formed from any of a number of different materials, or combinations of materials, and in some embodiments may be formed from a stamped piece of sheet metal. In some embodiments, the material of fastener 1400-a is selected to have a hardness that is greater than the hardness of the securement features 125-i and 130-i, and thereby provide similar properties and behaviors as discussed above with respect to FIGS. 3 and 5.

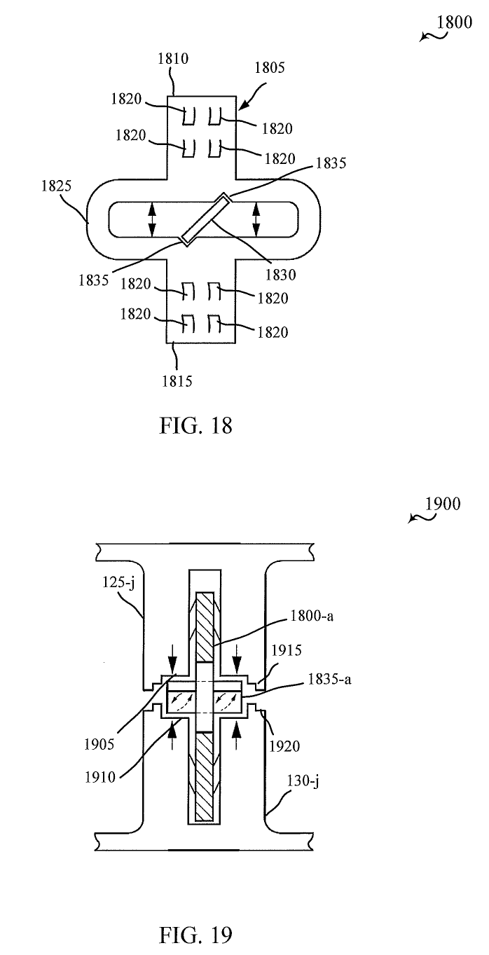

With reference now to FIGS. 18-19, another slot fastener and tensioning member 1800 of a set of embodiments is described. Fastener 1800 may be an example of one or more fasteners 120-a-120-c of FIG. 1. In the example of FIG. 18, fastener 1800 is a slot fastener having a body portion 1805, a first end portion 1810, and a second end portion 1815. In this example, end portions 1810 and 1815 are in the form of a sheet or plate that may be inserted into a slot, and have a number of cantilevered beams 1820 that extend therefrom. The cantilevered beams 1820 extend away from each respective end portion 1810, 1815 and toward the opposing end portion 1815, 1810, respectively. Cantilever beams 1820 and body portion 1805 may have physical characteristics related to flexing, thickness, and material properties similar to cantilevered beams 220 and body portion 205 of FIG. 2, which are not repeated here for the sake of brevity.

The fastener 1800 of FIG. 18 also includes a tensioning member 1825 in the form of an oval spring formed from sheet material of the fastener 1800. According to this example, tensioning member 1825 may be expanded and secured in an open state with a standoff 1830 that is lodged between cutouts 1835 on opposite sides of tensioning member 1825, as indicated in FIG. 18. Tensioning member 1825 may be expanded, for example, by pulling end portions 1810 and 1815 apart, thus expanding tensioning member 1825. According to some embodiments, standoff 1830 may be placed in tensioning member 1825 and hold the tensioning member 1825 in such an expanded state. Standoff 1830 may extend beyond the plane of the tensioning member such that an edge of the standoff 1830 may be pushed to force the standoff 1830 out of the cutouts 1835 and thus allow end portions 1810 and 1815 to move toward one another. Similarly as discussed above, fastener 1800 may be made from a stamped piece of sheet metal, and expanded tensioning member 1825 acts as a spring that biases end portions 1410 and 1415 toward each other. In the embodiments illustrated, the standoff 1830 may be stamped from the same piece of sheet metal.

With reference now to FIG. 19, cross-sections 1900 of a portion of housing securement features 125-j and 130-j and a slot fastener with tensioning member 1800-a is described in accordance with various embodiments. In the example of FIG. 19, fastener 1800-a may be used to couple a first securement feature 125-j and a second securement feature 130-j, and provide a biasing force that biases first and second securement features 125-j and 130-j towards each other. Fastener 1800-a may be an example of fastener 1800 of FIG. 18, and may be an example of one or more fasteners 120-a-120-c of FIG. 1. Securement feature 125-j may be an example of one or more of securement features 125-a-125-c of FIG. 1. Likewise, securement feature 130-j may be an example of one or more of securement features 130-a-130-c of FIG. 1. In this example, securement feature 125-j includes a ledge 1905 that is configured to engage with standoff 1835-a. Similarly, securement feature 130-j includes a ledge 1810 that is configured to engage with standoff 1835-a.

Initially, standoff 1835-a may be engaged with notch 1835, as described with respect to FIG. 18, when securement features 125-j and 130-j are aligned, but not yet fully engaged, and as securement features 125-j and 130-j are moved toward each other, as illustrated by the arrows in FIG. 19, ledges 1905 and 1910 engage with standoff 1835-a and move the ends of standoff 1835-a is opposite directions out of the notches 1835, thereby allowing the tensioning member 1825 to bias securement features 125-j and 130-j towards each other. In such a manner, securement features 125-j and 130-j may be securely held in place. Cantilevered beams located on the fastener 1800-a may operate in a similar fashion as described in any one or more of the above examples, and need not be described in any further detail here. Securement feature 125-j in this example includes alignment features 1915 that may engage with complimentary alignment features 1920 of securement feature 130-j, and may assist in maintaining proper alignment of the connected component pieces.

Similarly as discussed above, fastener 1800-a may be formed from any of a number of different materials, or combinations of materials, and in some embodiments may be formed from a stamped piece of sheet metal. In some embodiments, the material of fastener 1800-a is selected to have a hardness that is greater than the hardness of the securement features 125-j and 130-j, and thereby provide similar properties and behaviors as discussed above with respect to FIGS. 3 and 5.

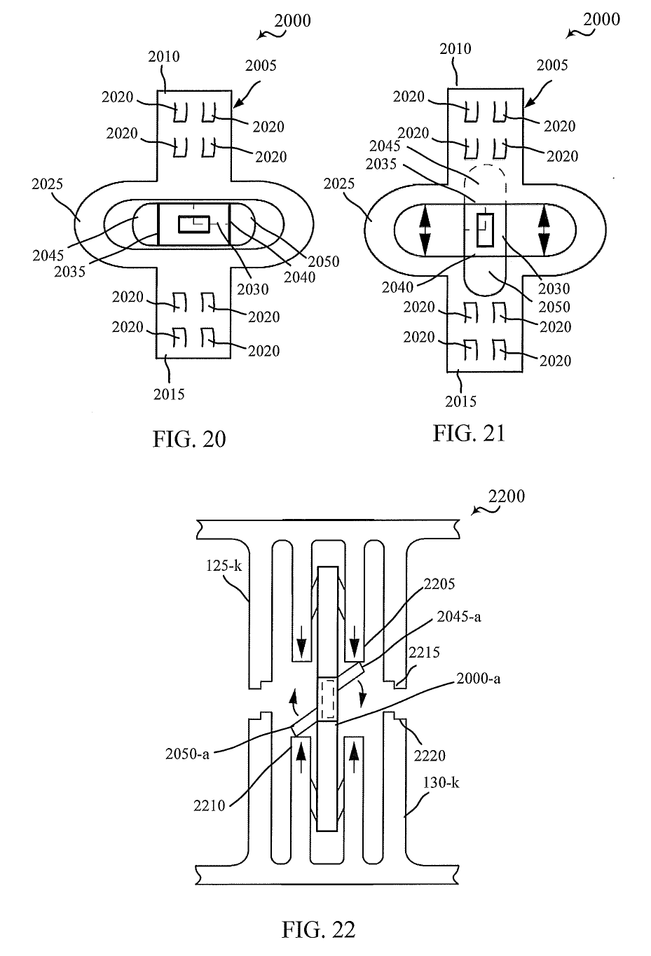

With reference now to FIGS. 20-22, another slot fastener and tensioning member 2000 of a set of embodiments is described. Fastener 2000 may be an example of one or more fasteners 120-a-120-c of FIG. 1. In the example of FIGS. 20-21, fastener 2000 is a slot fastener having a body portion 2005, a first end portion 2010, and a second end portion 2015. In this example, end portions 2010 and 2015 are in the form of a sheet or plate that may be inserted into a slot, and have a number of cantilevered beams 2020 that extend therefrom. The cantilevered beams 2020 extend away from each respective end portion 2010, 2015 and toward the opposing end portion 2015, 2010, respectively. Cantilever beams 2020 and body portion 2005 may have physical characteristics related to flexing, thickness, and material properties similar to cantilevered beams 220 and body portion 205 of FIG. 2, which are not repeated here for the sake of brevity.

The fastener 2000 of FIGS. 20 and 21 also includes a tensioning member 2025 in the form of an oval spring formed from sheet material of the fastener 2000. According to this example, tensioning member 2025 may be expanded and secured in an open state with a standoff 2030 that is formed from a cutout of the stamping used to make oval tensioning member 2025. Standoff 2030 may be formed to have ledges 2035 and 2040 that are configured to engage with opposite edges of tensioning member 2025, and tabs 2045 and 2050 that may be used to dislodge standoff 2030 from tensioning member 2025. Tensioning member 2025 may be expanded, for example, by pulling end portions 2010 and 2015 apart, thus expanding tensioning member 2025. According to some embodiments, standoff 2030 may be placed in tensioning member 2025 and hold the tensioning member 2025 in such an expanded state, as illustrated in FIG. 21. Tabs 2045, 2050, may extend beyond the plane of the tensioning member 2025 and may be contacted to force the standoff 2030 out of the tensioning member 2025 and thus allow end portions 2010 and 2015 to move toward one another. Similarly as discussed above, fastener 2000 may be made from a stamped piece of sheet metal, and expanded tensioning member 2025 acts as a spring that biases end portions 2010 and 2015 toward each other. In the embodiments illustrated, the standoff 2030 may be stamped from the same piece of sheet metal.

With reference now to FIG. 22, cross-sections 2200 of a portion of housing securement features 125-k and 130-k and a slot fastener with tensioning member 2000-a is described in accordance with various embodiments. In the example of FIG. 22, fastener 2000-a may be used to couple a first securement feature 125-k and a second securement feature 130-k, and provide a biasing force that biases first and second securement features 125-k and 130-k towards each other. Fastener 2000-a may be an example of fastener 2000 of FIGS. 20-21, and may be an example of one or more fasteners 120-a-120-c of FIG. 1. Securement feature 125-k may be an example of one or more of securement features 125-a-125-c of FIG. 1. Likewise, securement feature 130-k may be an example of one or more of securement features 130-a-130-c of FIG. 1. In this example, securement feature 125-k includes a slot leading edge 2205 that is configured to engage with standoff tab 2045-a. Similarly, securement feature 130-k includes a slot leading edge 2010 that is configured to engage with standoff tab 2050-a.

Initially, standoff 2035-a may be engaged with tensioning member 2025, as described with respect to FIG. 21, when securement features 125-k and 130-k are aligned, but not yet fully engaged, and as securement features 125-k and 130-k are moved toward each other, as illustrated by the arrows in FIG. 22, leading edges 2205 and 2210 engage with tabs 2045-a and 2050-a and move the ends of standoff 2035-a in opposite directions and releases the standoff from the tensioning member 2025, thereby allowing the tensioning member 2025 to bias securement features 125-k and 130-k towards each other. In such a manner, securement features 125-k and 130-k may be securely held in place. Cantilevered beams located on the fastener 2000-a may operate in a similar fashion as described in any one or more of the above examples, and need not be described in any further detail here. Securement feature 125-k in this example includes alignment features 2215 that may engage with complimentary alignment features 2220 of securement feature 130-k, and may assist in maintaining proper alignment of the connected component pieces.

Similarly as discussed above, fastener 2000-a may be formed from any of a number of different materials, or combinations of materials, and in some embodiments may be formed from a stamped piece of sheet metal. In some embodiments, the material of fastener 2000-a is selected to have a hardness that is greater than the hardness of the securement features 125-k and 130-k, and thereby provide similar properties and behaviors as discussed above with respect to FIGS. 3 and 5.

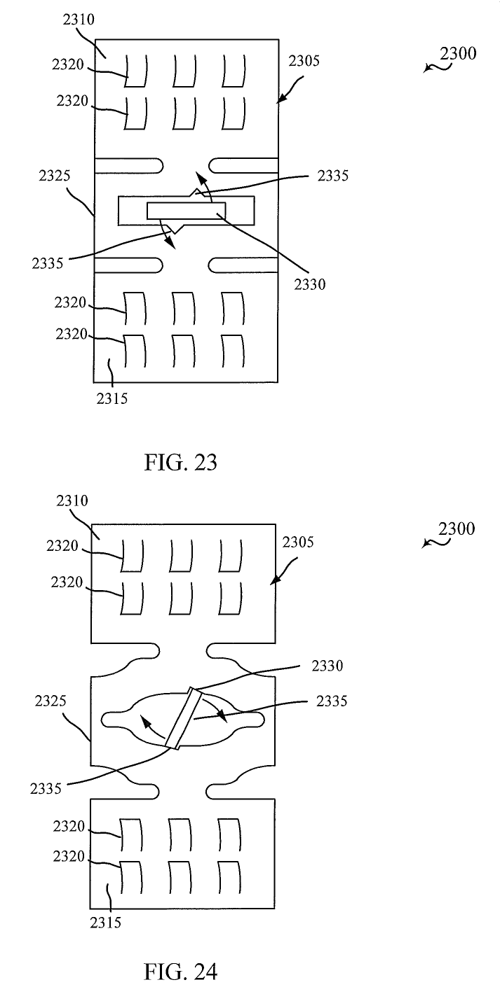

With reference now to FIGS. 23-24, another slot fastener and tensioning member 2300 of a set of embodiments is described. Fastener 2300 may be an example of one or more fasteners 120-a-120-c of FIG. 1. In the example of FIGS. 23-24, fastener 2300 is a slot fastener having a body portion 2305, a first end portion 2310, and a second end portion 2315. In this example, end portions 2310 and 2315 are in the form of a sheet or plate that may be aligned with and inserted into a slot, and have a number of cantilevered beams 2320 that extend therefrom, and operate in a similar fashion as described in various of the examples discussed above. The fastener 2300 of FIGS. 23 and 24 also includes a tensioning member 2325 in the form of a spring formed from sheet material of the fastener 2300. According to this example, tensioning member 2325 may be expanded and secured in an open state with a standoff 2330 that is formed from a cutout of the stamping used to make tensioning member 2325.

Standoff 2330 may be rotated to engage with notches 2335 located in opposite edges of tensioning member 2325, and may extend beyond the plane of tensioning member 2325 such that standoff 2330 may be released when coupled with one or more securement features. Tensioning member 2325 may be expanded, for example, by pulling end portions 2310 and 2315 apart, thus expanding tensioning member 2325. According to some embodiments, standoff 2330 may be placed in tensioning member 2325 and hold the tensioning member 2325 in such an expanded state, or unbiased state, as illustrated in FIG. 24. When standoff 2330 is released, end portions 2310 and 2315 may move toward one another and bias any coupled securement features towards each other as well. Similarly as discussed above, fastener 2300 may be made from a stamped piece of sheet metal, and may have properties similarly as discussed in any of the various examples above.

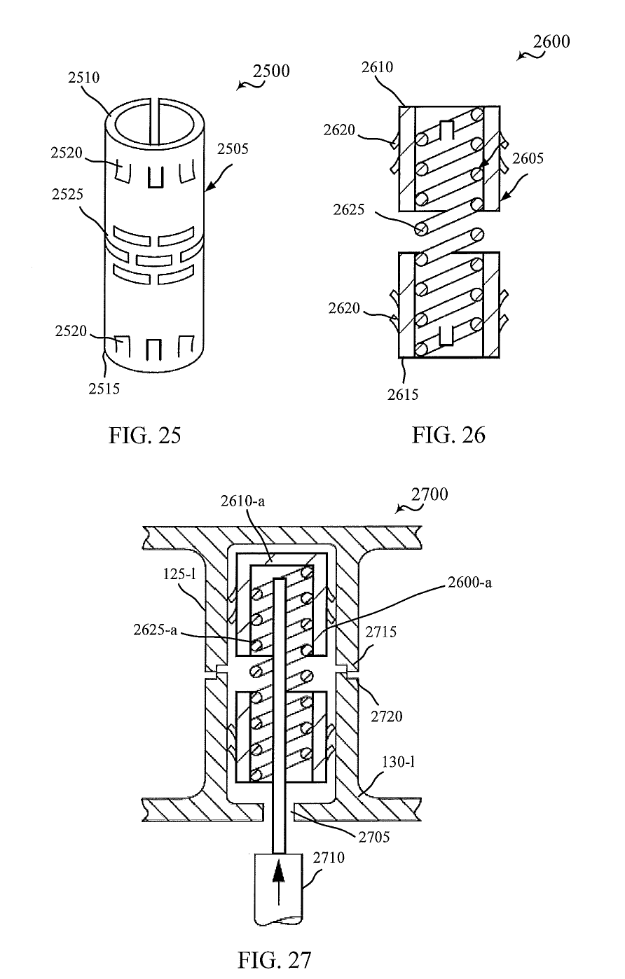

With reference now to FIG. 25, a post fastener and tensioning member 2500 of a set of embodiments is described. Fastener 2500 may be an example of one or more fasteners 120-a-120-c of FIG. 1. In the example of FIG. 25, fastener 2500 is a post fastener having a body portion 2505, a first end portion 2510, and a second end portion 2515. In this example, end portions 2510 and 2515 are in the form of a post that may be inserted into a socket of a securement feature, and have a number of cantilevered beams 2520 that extend therefrom, and operate in a similar fashion as described in various of the examples discussed above. The fastener 2500 of FIG. 25 also includes a tensioning member 2525 in the form of a spring formed from sheet material of the fastener 2500. According to this example, tensioning member 2525 may be expanded and secured in an open state, such as through the use of a standoff similarly as discussed above. Tensioning member 2525 may be expanded, for example, by pulling end portions 2510 and 2515 apart, thus expanding tensioning member 2525. When coupled with securement features, end portions 2310 and 2315 may move toward one another and bias the coupled securement features towards each other. Similarly as discussed above, fastener 2300 may be made from a stamped piece of sheet metal, and may have properties similarly as discussed in any of the various examples above.

With reference now to FIG. 26, a post fastener and tensioning member 2600 of a set of embodiments is described. Fastener 2600 may be an example of one or more fasteners 120-a-120-c of FIG. 1. In the example of FIG. 26, fastener 2600 is a post fastener having a body portion 2605, a first end portion 2610, and a second end portion 2615. In this example, end portions 2610 and 2615 are in the form of a post that may be inserted into a socket of a securement feature, and have a number of cantilevered beams 2620 that extend therefrom, and operate in a similar fashion as described in various examples discussed above. The fastener 2600 of FIG. 26 also includes a tensioning member 2625 in the form of a coil spring that is placed inside of the fastener 2600. According to this example, tensioning member 2625 may be coupled with end portions 2610 and 2615 and may be expanded and secured in an open state, such as through the use of a standoff similarly as discussed above. Tensioning member 2625 may be expanded, for example, by pulling end portions 2610 and 2615 apart, thus expanding tensioning member 2625. When coupled with securement features, end portions 2310 and 2315 may move toward one another and bias the coupled securement features towards each other. Similarly as discussed above, fastener 2300 may be made from a stamped piece of sheet metal, and may have properties similarly as discussed in any of the various examples above.

With reference now to FIG. 27, cross-sections 2700 of a portion of housing securement features 125-l and 130-l and a post fastener with tensioning member 2600-a is described in accordance with various embodiments. In the example of FIG. 27, fastener 2600-a may be used to couple a first securement feature 125-l and a second securement feature 130-l, and provide a biasing force that biases first and second securement features 125-I and 130-I towards each other. Fastener 2600-a may be an example of fastener 2600 of FIG. 26, and similar principles would apply to a fastener 2500 such as described with respect to FIG. 25. Fastener 2600-a may be an example of one or more fasteners 120-a-120-c of FIG. 1. Securement feature 125-I may be an example of one or more of securement features 125-a-125-c of FIG. 1. Likewise, securement feature 130-I may be an example of one or more of securement features 130-a-130-c of FIG. 1. In this example, securement feature 130-I includes an aperture 2705 that may receive a insertion tool 2710 that is configured to be inserted through aperture 2705 and engage an end surface 2610-a of fastener 2600-a.

Insertion tool 2710 may be used to apply force to the end surface 2610-a and push the end 2610-a further into the socket of securement feature 125-l. Tensioning member 2625-a may thus pull the ends of fastener 2600-a toward each other and bias the securement features together. Cantilevered beams located on the fastener 2600-a may operate in a similar fashion as described in any one or more of the above examples, and need not be described in any further detail here. Securement feature 125-l in this example includes alignment features 2715 that may engage with complimentary alignment features 2720 of securement feature 130-l, and may assist in maintaining proper alignment of the connected component pieces.

Similarly as discussed above, fastener 2000-a may be formed from any of a number of different materials, or combinations of materials, and in some embodiments may be formed from a stamped piece of sheet metal. In some embodiments, the material of fastener 2000-a is selected to have a hardness that is greater than the hardness of the securement features 125-I and 130-I, and thereby provide similar properties and behaviors as discussed above with respect to FIGS. 3 and 5.

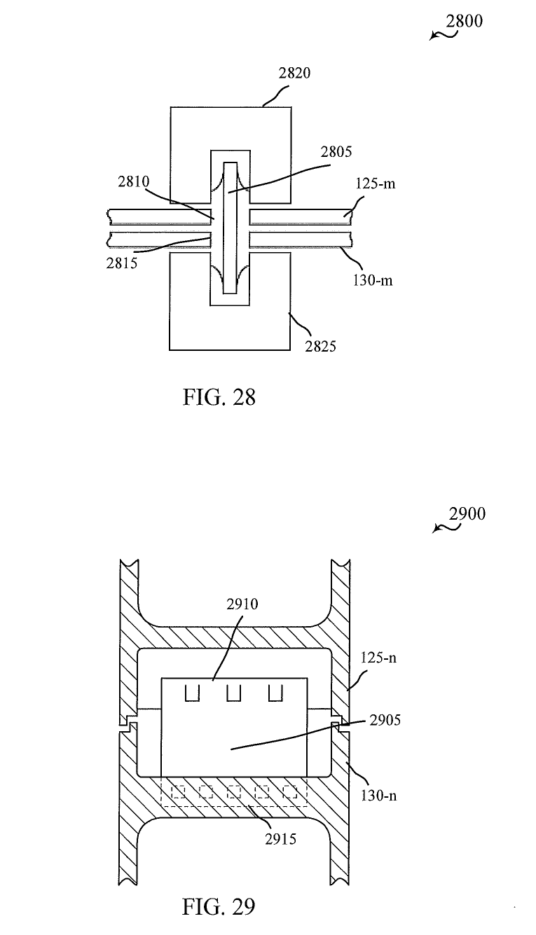

With reference now to FIG. 28, a cross section 2800 of molded retainers that may be engaged with a fastening clip that extends through securement features is described for various embodiments. While various embodiments use molded retainers, such devices may also be die cast, machined, or formed by other processes. In FIG. 28, a fastener 2805 may extend through apertures 2810, 2815, in the respective sidewalls of securement features 125-m and 130-m, and be coupled to molded retainers 2820 and 2825. In such a manner, the apertures 2810 and 2815 may be aligned to allow passage of an end portion of fastener 2805 to extend therethrough. Molded retainers 2820 and 2825 may be coupled with the exposed ends of fastener 2805, and retain securement features 125-m and 130-m together. Securement feature 125-m may be an example of one or more of securement features 125-a-125-c of FIG. 1. Likewise, securement feature 130-m may be an example of one or more of securement features 130-a-130-c of FIG. 1. Cantilevered beams located on the fastener 2805 may operate in a similar fashion as described in any one or more of the above examples, and need not be described in any further detail here.

Similarly as discussed above, fastener 2805 may be formed from any of a number of different materials, or combinations of materials, and in some embodiments may be formed from a stamped piece of sheet metal. In some embodiments, the material of fastener 2805 is selected to have a hardness that is greater than the hardness of the molded retainers 2820 and 2925, and thereby provide similar properties and behaviors as discussed above with respect to FIGS. 3 and 5.

With reference now to FIG. 29, a cross section 2900 of an overmolded fastener is described for various embodiments. In FIG. 29, a fastener 2905 may have a first end 2910 that may engage a securement feature 125-n in a manner similarly as described in any one of the above examples. Fastener 2905 has a second end 2915 that, in this embodiment, is overmolded with securement feature 130-n. Optionally, end 2915 could be secured to feature 130-n by other fastening methods including adhesives, threaded fasteners, pins and/or other mechanical interlocking features, as will be readily apparent to one skilled in the art. Thus, securement features, and associated component pieces, may be secured together when securement feature 125-n is coupled with end 2910 of the fastener 2905. Cantilevered beams located on the fastener 2905 may operate in a similar fashion as described in any one or more of the above examples, and need not be described in any further detail here. Securement feature 125-n may be an example of one or more of securement features 125-a-125-c of FIG. 1. Likewise, securement feature 130-n may be an example of one or more of securement features 130-a-130-c of FIG. 1.

Similarly as discussed above, fastener 2905 may be formed from any of a number of different materials, or combinations of materials, and in some embodiments may be formed from a stamped piece of sheet metal. In some embodiments, the material of fastener 2805 is selected to have a hardness that is greater than the hardness of the securement feature 125-n, and thereby provide similar properties and behaviors as discussed above with respect to FIGS. 3 and 5.

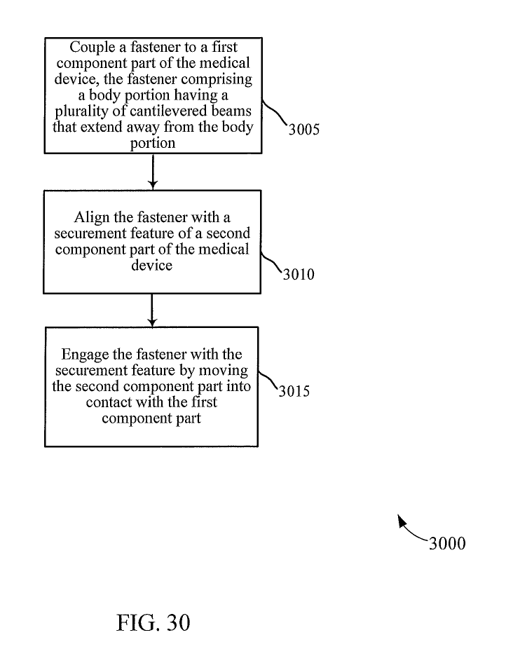

With reference now to FIG. 30 a flow chart 3000 of the operations for assembling a device using a fastener in accordance with various embodiments is described. Such operations may be used to assemble medical device 100 of FIG. 1, for example. Initially, at block 3005, a fastener is coupled to a first component part of the medical device, the fastener including a body portion having from one to a plurality of cantilevered beams that extend away from the body portion. Such a fastener may include any of the above described fasteners, for example. At block 3010, the fastener is aligned with a securement feature of a second component part of the medical device. The first and second component parts may be, for example, different sides of an external housing of the medical device. Finally, at block 3015, the fastener is engaged with the securement feature by moving the second component part into contact with the first component part. As noted above, the fastener may include cantilevered beams that act to secure the fastener with the securement features of the component parts. According to some examples, such as described above, the fastener may include one or more tensioning members that act to bias the securement features toward one another, and thereby maintain the assembled pieces in a secure fashion.

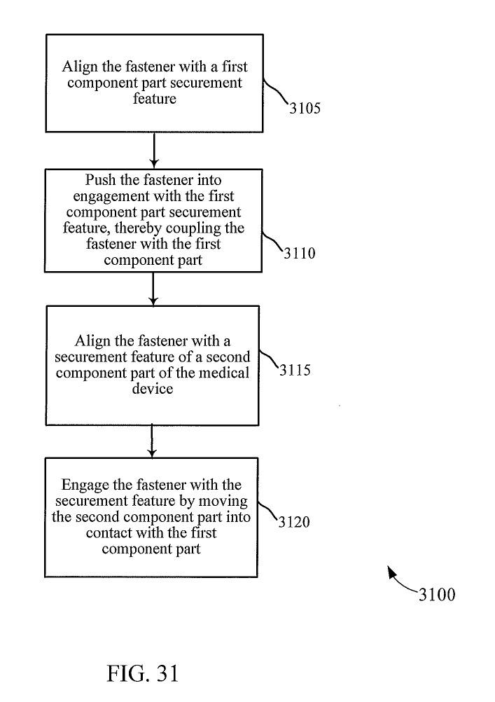

With reference now to FIG. 31 a flow chart 3100 of the operations for assembling a device using a fastener in accordance with other various embodiments is described. Such operations may be used to assemble medical device 100 of FIG. 1, for example. Initially, at block 3105, the fastener is aligned with a first component part securement feature. At block 3110, the fastener is pushed into engagement with the first component part securement feature, thereby coupling the fastener with the first component part. Such a fastener may include any of the above described fasteners, for example. At block 3115, the fastener is aligned with a securement feature of a second component part of the medical device. The first and second component parts may be, for example, different sides of an external housing of the medical device. Finally, at block 3120, the fastener is engaged with the securement feature by moving the second component part into contact with the first component part. As noted above, the fastener may include cantilevered beams that act to secure the fastener with the securement features of the component parts. According to some examples, such as described above, the fastener may include one or more tensioning members that act to bias the securement features toward one another, and thereby maintain the assembled pieces in a secure fashion.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of embodiments of the principles described herein.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the principles described herein. For example, the above elements may merely be a component of a larger system, wherein other rules may take precedence over or otherwise modify the application of the principles described herein. Also, a number of steps may be undertaken before, during, or after the above elements are considered. Accordingly, the above description should not be taken as limiting the scope of the invention.

What is claimed is:

1. An apparatus for securing a component piece to a medical device, comprising:
a body portion having a first end portion and a second end portion, the first end portion configured to engage a securement feature of a first component piece; and
a plurality of cantilevered beams on the first end portion, one or more of the cantilevered beams having a distal end that extends away from the second end portion toward a distal end of the first end portion,
wherein one or more of the cantilevered beams are configured to engage the securement feature of the component piece.

2. The apparatus of claim 1, wherein the second end portion comprises a second plurality of cantilevered beams, one or more of the second plurality of cantilevered beams having a distal end that extends away from the first end portion toward a distal end of the second end portion, and
wherein one or more of the second plurality of cantilevered beams are configured to engage a second securement feature of the medical device.

3. The apparatus of claim 1, further comprising:
a tensioning member coupled between the first and second end portions and configured to bias the first end portion toward the second end portion.

4. The apparatus of claim 3, wherein the tensioning member comprises a spring coupled to each of the first and second end portions.

5. The apparatus of claim 4, wherein the tensioning member further comprises a standoff that maintains the spring in an unbiased state, and
wherein the securement feature of the component piece releases the standoff and allows the spring to bias the first end portion toward the second end portion.

6. The apparatus of claim 4, wherein the spring comprises an oval spring, and the first and second end portions are coupled with opposite sides of the oval spring.

7. The apparatus of claim 4, wherein at least one of the component piece and medical device comprise an aperture aligned with the spring and configured to receive an insertion tool for preloading the spring.

8. The apparatus of claim 1, wherein the component piece is configured to be overcompressed when engaged with the medical device and body portion.

9. The apparatus of claim 1, wherein the body portion comprises a round post, and wherein the securement feature comprises a socket aligned to receive the round post and engage one or more of the cantilevered beams.

10. The apparatus of claim 1, wherein the body portion comprises a plate, and wherein the securement feature comprises a slot aligned to receive the plate and engage one or more of the cantilevered beams.

11. The apparatus of claim 1, wherein the body portion comprises a clip, and wherein the securement feature comprises a rib aligned to be inserted into the clip and engage one or more of the cantilevered beams.

12. The apparatus of claim 1, wherein the body portion comprises a round post and the cantilevered beams extend into an inner portion of the round post, and
wherein the securement feature comprises a socket having a central grip post, the socket aligned to receive the round post and the grip post aligned to insert into the inner portion of the round post and engage one or more of the cantilevered beams.

13. The apparatus of claim 1, wherein the body portion further comprises a third end portion configured to engage a securement feature of a second component piece.

14. The apparatus of claim 1, wherein the second end portion comprises an aperture configured to receive a fastener that couples the body portion to the medical device.

15. The apparatus of claim 14, wherein the fastener comprises one or more of a screw, a rivet, or a post.

16. The apparatus of claim 1, wherein the second end portion is overmolded into the medical device.

17. The apparatus of claim 1, wherein the cantilever beams extend between 0 and 90 degrees from a surface of the securement feature that is to be contacted.

18. The apparatus of claim 1, wherein the component piece comprises:
an aperture aligned to allow passage of the second end portion; and
a molded retainer configured to be engaged with the second end portion and secure the component piece to the medical device.

19. The apparatus of claim 1, wherein the body portion is stamped and formed from single piece of metal.

20. The apparatus of claim 19, wherein the cantilevered beams are stamped to extend away from the single piece of metal.
